(19) United States
(12) Patent Application Publication
(10) Pub. No.: US 2015/0278123 A1
(43) Pub. Date: Oct. 1, 2015

(54) LOW-OVERHEAD DETECTION OF UNAUTHORIZED MEMORY MODIFICATION USING TRANSACTIONAL MEMORY

(71) Applicants: Alex Nayshtut, Gan Yavne, IL (US); Igor Muttik, Aylesbury (GB); Roman Dementiev, Heidelberg (DE)

(72) Inventors: Alex Nayshtut, Gan Yavne, IL (US); Igor Muttik, Aylesbury (GB); Roman Dementiev, Heidelberg (DE)

(21) Appl. No.: 14/228,842

(22) Filed: Mar. 28, 2014

(51) Int. Cl. G06F 12/14

(52) U.S. Cl. CPC G06F 12/1433

(57) ABSTRACT

Technologies for detecting unauthorized memory accesses include a computing device having transactional memory support. The computing device executes a transactional memory execution envelope within a security thread. Within the transactional envelope, the security thread reads one or more memory locations. The computing device detects a transactional abort originating from the transactional envelope, and determines whether a security event has occurred. A security event may include an unauthorized write to the monitored memory locations from outside the transactional envelope, including from non-transactional code. The computing device reports any security events that are detected. The computing device may execute several security threads that each monitor a different, non-overlapping memory location. The computing device may spawn a new security thread to monitor a memory location while a previous security thread is handling a transactional abort. Other embodiments are described and claimed.

### BACKGROUND

One aspect of computer security involves protecting computer systems from malicious software, also known as “malware.” Malware comes in many forms; however, many common varieties of malware perform writes or other accesses to unauthorized locations in computer memory. For example, certain malware modifies critical in-memory system data structures to gain control over a computer. One such attack involves overwriting the system call table so that code supplied by the malware is executed in place of one or more system calls. Such an attack may be used by so-called “rootkits” to gain control of a system and evade detection. As another example, some malware causes the system to execute code from unauthorized memory segments such as the system stack or data segments. For example, buffer overflow exploits, return-oriented programming (ROP) gadgets, and similar exploits cause the system to execute code from (or driven by) the system stack or heap that should not ordinarily be executed. Malware may perform such attacks to execute so-called “shellcode” attacks; that is, to execute arbitrary code (usually introduced from a remote location) on the computer system.

Typical computer security systems attempt to detect malware by applying code analysis to classify potentially malicious code. For example, a computer security system may perform static analysis of code to search for well-known malware signatures. Some systems may also perform dynamic analysis of code execution. Typical dynamic monitoring, such as single-stepping execution using a hypervisor, has a large negative impact on system performance.

Some computer processors provide support for hardware transactional memory. Transactional memory allows the programmer to designate a segment of code called a “transaction” to execute independently and atomically. That is, memory operations occurring within the transaction are not visible to other transactions or threads executing on the computing system until the transaction is successfully committed. After successful commit, all memory changes made during the transaction are instantaneously available to other threads on the system. Transactional memory may be implemented by speculatively executing the transaction, detecting any memory conflicts that occur during execution of the transaction, and then aborting and rolling back the transaction in response to memory conflicts. Memory conflicts include, for example, a transaction attempting to write to a memory location that has already been read or written-to by another transaction. Transactional memory may simplify the programming model for parallel computing. One commercially available example of hardware transactional memory support is Transactional Synchronization Extensions (Intel® TSX), available on certain processors manufactured by Intel® Corporation.

As described in pending international application PCT/US2013/075805, filed on Dec. 17, 2013, unauthorized memory accesses may be detected by wrapping suspicious code into a transaction and concurrently reading a protected memory region from another transaction. Any read-write conflict between the transactions generates a transactional abort, and thus unauthorized changes to the protected memory region may be rolled back automatically.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for detection of unauthorized memory access;

FIG. 2 is a simplified block diagram of at least one embodiment of an environment of the computing device of FIG. 1;

FIG. 3 is a simplified flow diagram of at least one embodiment of a method for detecting unauthorized memory access that may be executed by the computing device of FIGS. 1 and 2;

FIG. 4 is a simplified flow diagram of at least one embodiment of a method for dispatching security monitoring threads that may be executed by the computing device of FIGS. 1 and 2;

FIG. 5 is an activity diagram illustrating operation of a number of security monitoring threads; and

FIG. 6 is a simplified flow diagram of at least one embodiment of a method for executing suspicious code that may be executed by the computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

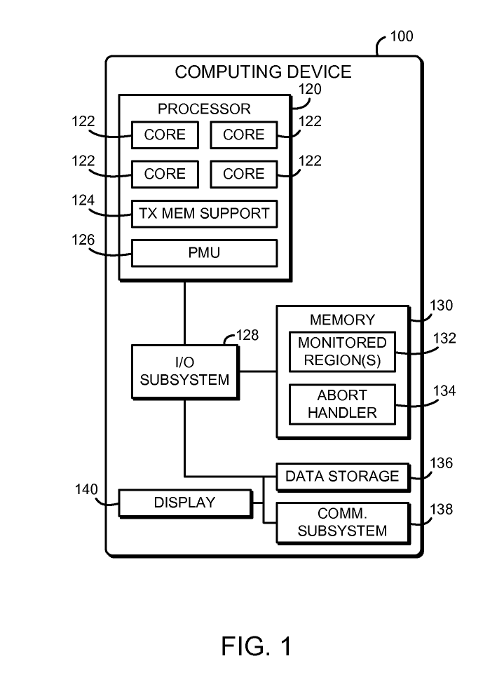

Referring now to FIG. 1, an illustrative computing device 100 may be used for detection of unauthorized memory accesses. The computing device 100 may execute one or more security threads that each start a transaction and, within the transaction, read a particular set of monitored memory regions. The security threads and their corresponding transactions remain pending while other code (e.g., operating system, hypervisor, application code, or other code) executes on the computing device 100. Any writes originating from code outside of the transactions to the monitored memory regions causes a transactional abort to be generated and handled by a security thread. The security thread may report a security event, halt the computing device 100, or perform any other appropriate action in response to detecting the transactional abort. Transactional monitoring allows the computing device 100 to monitor for changes to critical memory segments in real-time without modifying or wrapping executing code (e.g., without injecting transaction begin/end instructions). Additionally, compatibility with executing code may be improved by reducing the nested transaction level of the executing code. Also, by using several monitoring threads, limitations in the size of transactional memory buffers may be avoided.

The computing device 100 may be embodied as any type of device for performing the functions described herein. For example, the computing device 100 may be embodied as, without limitation, a desktop computer, a server computer, a workstation, a laptop computer, a notebook computer, a mobile computing device, a smart phone, a tablet computer, a cellular telephone, a handset, a messaging device, a wearable computing device, a vehicle telematics device, a distributed computing system, a multiprocessor system, a consumer electronic device, an embedded controller, and/or any other computing device configured to perform the functions described herein. As shown in FIG. 1, the illustrative computing device 100 includes a processor 120, an input/output subsystem 128, a memory 130, and a data storage device 136. Of course, the computing device 100 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 120 in some embodiments (e.g. in implementations where the processor cache is used as random-access memory).

The processor 120 may be embodied as any type of processor capable of performing the functions described herein. The illustrative processor 120 is a multi-core processor; however, in other embodiments the processor 120 may be embodied as a single or multi-core processor(s), digital signal processor, microcontroller, or other processor or processing/controlling circuit. The illustrative processor 120 includes four processor cores 122, each of which is an independent processing unit capable of executing programmed instructions. Although the illustrative processor 120 includes four processor cores 122, the processor 120 may include a fewer or greater number of processor cores 122 in other embodiments. Additionally, although the illustrative computing device 100 includes a single processor 120, in some embodiments the computing device 100 may include more than one processor 120. For example, the computing device 100 may be embodied as a symmetric multiprocessing system with shared memory interconnects. The illustrative processor 120 further includes hardware transactional memory support 124 and a performance monitoring unit (PMU) 126.

The transactional memory support 124 allows the processor 120 to speculatively execute segments of code known as transactions. Transactions are atomic, meaning that memory operations performed by a transaction while the transaction is pending are not visible to other transactions, cores, logical processors, and/or threads of the processor 120. When a transaction is completed, also known as committed, all of the memory operations of the transaction become available to the rest of the computing device 100 at once. When memory accesses within a transaction conflict with another transaction or thread, for example when a thread writes to a memory location that has been read by an uncommitted transaction (or when two transactions and/or threads write to the same memory location), the processor 120 may abort the conflicting transaction(s), discarding any associated in-progress transactional memory changes. In particular, the processor 120 may “eagerly” abort the conflicting transaction immediately upon detecting a memory conflict, without waiting for the transaction to attempt to commit The processor 120 may use a cache coherency mechanism to implement eager conflict detection. The processor 120 may detect conflicting memory locations at any level of granularity, for example per cache line, per word, or per memory cell. On abort, the processor 120 may call an abort handler, restart the transaction (once or multiple times), or invoke non-transactional fallback code in response to an aborted transaction. In some embodiments, the transactional memory support 124 may be embodied as Intel® Transactional Synchronization Extensions (Intel® TSX), available on certain processors 120 manufactured by Intel® Corporation.

The PMU 126 may be embodied as a number of performance counters capable of recording and monitoring the flow of instructions through the processor 120. For example, the PMU 126 may be capable of reporting the precise memory address of an instruction causing a transactional abort (e.g., an explicit abort instruction or a breakpoint) or the memory address of a conflicting data location. Although illustrated as a single PMU 126, in some embodiments the processor 120 may include several PMUs 126, for example one PMU 126 for each processor core 122.

The memory 130 may be embodied as any type of volatile or non-volatile memory or data storage capable of performing the functions described herein. In operation, the memory 130 may store various data and software used during operation of the computing device 100 such as operating systems, applications, programs, libraries, and drivers. The illustrative memory 130 includes one or more monitored memory regions 132 and an abort handler 134. As described further below, the monitored memory regions 132 are specific regions of memory monitored for attempted unauthorized memory access. Such monitored memory regions 132 may include critical system memory structures such as the system call table, hardware interrupts table, system security software, or other important memory regions. The abort handler 134 may include a routine or routines that are called in the event of a transactional abort to handle potential security violations, as described further below. The memory 130 is communicatively coupled to the processor 120 via the I/O subsystem 128, which may be embodied as circuitry and/or components to facilitate input/output operations with the processor 120, the memory 130, and other components of the computing device 100. For example, the I/O subsystem 128 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 128 may form a portion of a system-on-a-chip (SoC) and be incorporated, along with the processor 120, the memory 130, and other components of the computing device 100, on a single integrated circuit chip.

The data storage device 136 may be embodied as any type of device or devices configured for short-term or long-term storage of data such as, for example, memory devices and circuits, memory cards, hard disk drives, solid-state drives, or other data storage devices. The data storage device 136 may be used to store software or other data for execution including operating system software and application software. Such software may be initially untrusted and potentially malicious, for example, software downloaded from a third party vendor.

The computing device 100 further includes a communication subsystem 138, which may be embodied as any communication circuit, device, or collection thereof, capable of enabling communications between the computing device 100 and remote computing devices. The communication subsystem 138 may be configured to use any one or more communication technology (e.g., wireless or wired communications) and associated protocols (e.g., Ethernet, Bluetooth®, Wi-Fi®, WiMAX, HSPA+, LTE, etc.) to effect such communication. The communication subsystem 138 may be embodied as a network adapter, including a wireless network adapter.

In the illustrative embodiment, the computing device 100 further includes a display 140. The display 140 of the computing device 100 may be embodied as any type of display capable of displaying digital information such as a liquid crystal display (LCD), a light emitting diode (LED), a plasma display, a cathode ray tube (CRT), or other type of display device. The display 140 may be used, for example, to convey results of security analysis to a user.

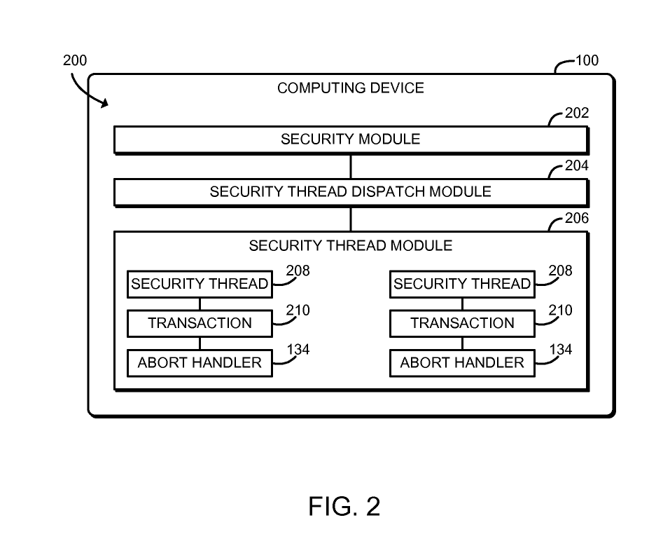

Referring now to FIG. 2, in the illustrative embodiment, the computing device 100 establishes an environment 200 during operation. The illustrative environment 200 includes a security module 202, a security thread dispatch module 204, and a security thread module 206. The various modules of the environment 200 may be embodied as hardware, firmware, software, or a combination thereof.

The security thread module 206 is configured to execute one or more security threads 208 concurrently with execution of other code by the computing device 100. Each security thread 208 starts a transactional memory transaction 210 and reads a monitored memory region 132 from within the transaction 210. The security thread 208 detects a transactional abort and handles the transactional abort using an associated abort handler 134. In response to detecting a transactional abort, the security thread 208 determines whether a security event has occurred and may report the security event. A security event may include an unauthorized access to the monitored memory region 132, including an unauthorized write from code executing outside of the transaction 210.

The security threads 208 may each be embodied as any independent thread of execution runnable on a core 122 or logical processor of the computing device 100, such as an operating system thread, a lightweight process, an operating system process, operating system kernel thread, or a user software thread. On creation, each security thread 208 may be supplied with the addresses of the monitored memory regions 132 or a part of the monitored memory regions 132. In some embodiments, rather than being newly created, the security threads 208 may be selected from a thread pool or otherwise pre-generated. The transactions 210 may each be embodied as any transactional memory envelope that may be executed by the processor 120, using the transactional memory support 124. Each of the transactions 210 may maintain a read set that records the locations within the memory 130 that have been read during execution of the transaction 210. The read set may be used to detect memory conflicts and trigger transactional aborts.

The security thread dispatch module 204 is configured to start one or more of the security threads 208. The security thread dispatch module 204 may assign parts of the monitored memory regions 132 to each of the security threads 208. The security thread dispatch module 204 may ensure that all of the monitored memory regions 132 are monitored, and that the monitored memory regions 132 assigned to each of the security threads 208 do not overlap. In some embodiments, the security thread dispatch module 204 may monitor performance of the security threads 208 and dynamically adjust the number of security threads 208 in use; for example, to adjust the number of security threads 208 based on the number of transactional aborts handled, or to assign a backup security thread 208 to cover monitored memory regions 132 while the primary security thread 208 executes an abort handler 134.

The security module 202 is configured to identify a suspicious code segment and wrap the suspicious code segment in a transactional execution envelope. The security module 202 may also be configured to identify particular memory locations within the suspicious code that should not be executed, for example suspected shellcode or suspected return-oriented programming (ROP) gadgets. The suspicious code, wrapped in the transactional envelope, may be executed concurrently with the security threads 208. Security events caused by the suspicious code, for example conflicting writes to the monitored memory regions 132, may cause a transactional abort. The transaction including the suspicious code may thus be aborted and rolled back, and the security event may be reported or otherwise processed. Accordingly, the security module 202 may be embodied as any component of the computing device 100 having access to the address space of the suspicious code (or to the image of the code on data storage 136 before the code is mapped into memory 130). For example, the security module 202 may be embodied as or part of a virtual machine monitor (VMM), hypervisor, operating system, kernel software, or other control system of the computing device 100.

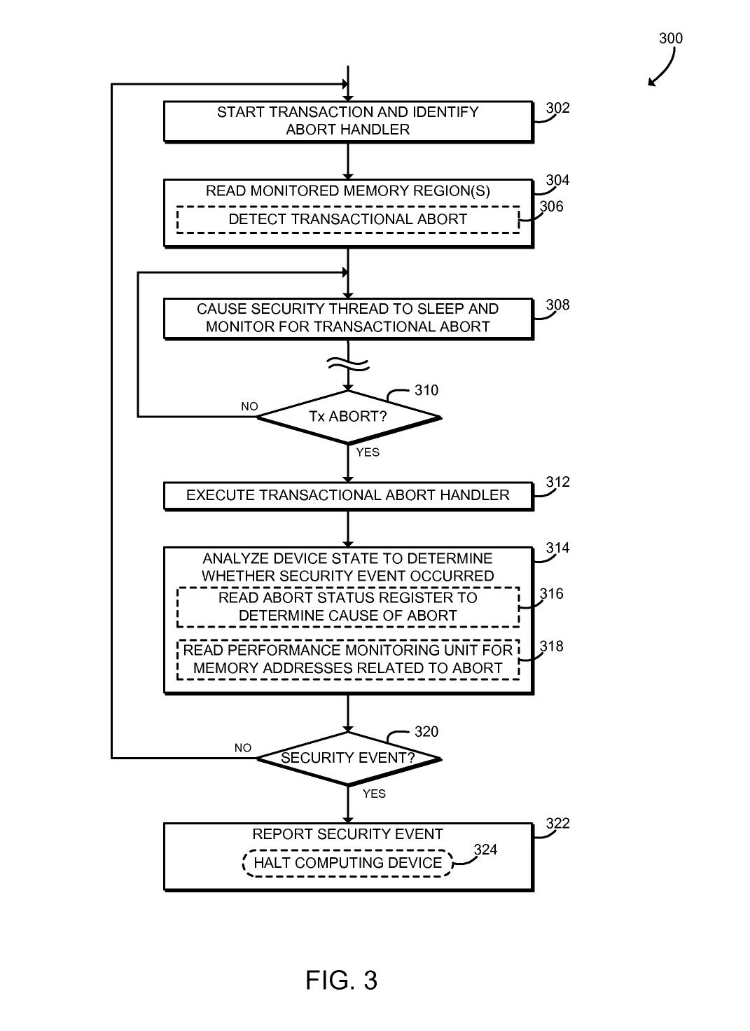

Referring now to FIG. 3, in use, the computing device 100 may execute a method 300 for detecting unauthorized memory accesses. The method 300 may be executed, for example, by a security thread 208 of the computing device 100. The method 300 begins in block 302, in which the computing device 100 starts a new transaction 210 and identifies an associated abort handler 134. In some embodiments, the transaction 210 may be started by executing a particular instruction, for example the XBEGIN instruction. The address of the abort handler 134 may be passed as an argument to the transaction-begin instruction. Additionally or alternatively, a separate instruction may exist for specifying address of the abort handler 134. As described above, if a transactional abort occurs during execution of the transaction 210, the processor 120 calls the abort handler 134.

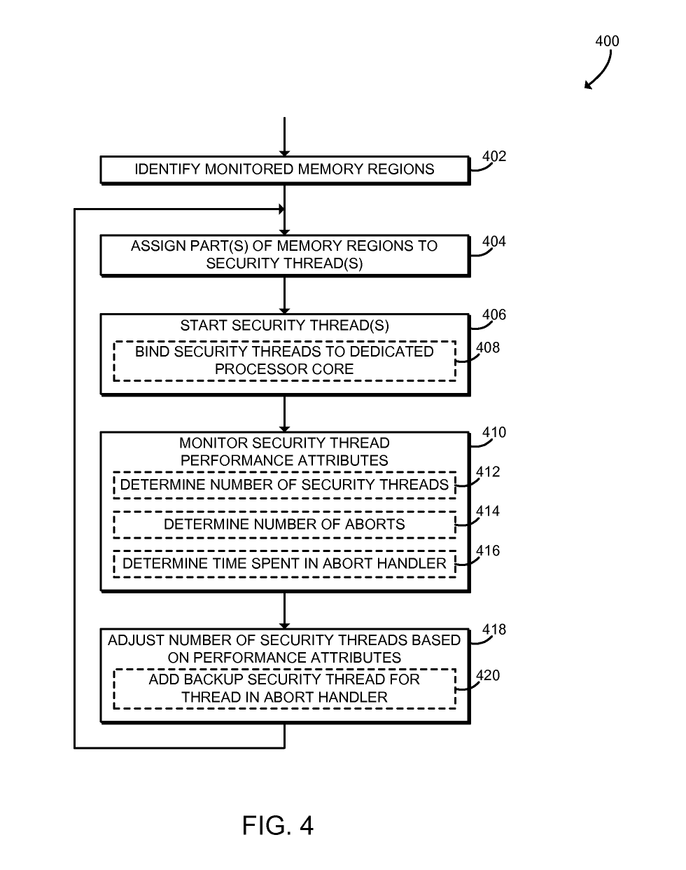

In block 304, the present security thread 208 of the computing device 100 reads one or more monitored memory regions 132 from within the transaction 210. As further described below in connection with FIG. 4, a particular security thread 208 may read less than all of the monitored memory regions 132 of the memory 130. Other security threads 208 executed contemporaneously by the computing device 100 may read the remaining monitored memory regions 132. Reading the monitored memory regions 132 adds the monitored memory regions 132 to a read set associated with the transaction 210. Thus, while reading the monitored memory regions 132, in block 306 the computing device 100 may detect a transactional abort, for example a transactional abort caused by a conflicting write to the monitored memory regions 132 from outside of the transaction 210. Such transactional aborts may be caused by non-transactional code or by code executing within a different transaction. Of course, transactional aborts may have other causes, such as exceeding hardware limits for transaction size, encountering an instruction not supported for transactional execution (e.g., an attempted I/O instruction), exceeding a nested transaction limit, or other causes.

In block 308, the computing device 100 causes the security thread 208 to sleep. While the security thread 208 is sleeping, the computing device 100 monitors for a transactional abort. As described above, the transactional abort may be caused by a memory conflict between the security thread 208 and other code executing on the computing device 100. As described above, transactional memory conflicts may occur, for example, when code from outside of the transaction 210 writes to a data location that is within the read set of the pending transaction 210. The detection of memory conflicts and subsequent generation of transactional aborts may be performed by hardware of the processor 120, microcode of the processor 120, firmware, software, or any combination of those techniques. Detection of memory conflicts and other transactional aborts may be transparent to software executing on the processor 120, which may become aware of a transactional abort only after the abort handler 134 is called by the processor 120. Thus, the computing device 100 may sleep or otherwise yield execution of the security thread 208 after loading the monitored memory regions 132 into the read set of the transaction 210 and still detect transactional aborts. Causing the security thread 208 to sleep may improve performance of the computing device 100 by reducing contention for computing resources. Of course, in some embodiments, the processor 120 may not be capable of detecting transactional aborts while a thread is sleeping; in those embodiments, the computing device 100 may continually, periodically, or responsively determine whether a transactional abort has occurred, for example by repeatedly reading from the monitored memory locations 132.

In block 310, the computing device 100 determines whether a transactional abort has occurred. As described above, hardware, microcode, firmware, or other components of the computing device 100 may transparently determine whether a transactional abort has occurred, even if the security thread 208 is sleeping. If no transactional abort has occurred, the method 300 loops back to block 308. If a transactional abort has occurred, the method 300 advances to block 312.

In block 312, the computing device 100 executes the abort handler 134. The computing device 100 may perform any appropriate processes for executing the abort handler 134. For example, the computing device 100 may automatically roll back any changes to memory made by the transaction 210 during execution of the security thread 208, and then invoke the abort handler 134.

In block 314, the computing device 100 analyzes device state of the computing device 100 to determine whether a security event has occurred. This analysis may be performed by the abort handler 134 or otherwise invoked in response to the abort handler 134 being called. A security event includes any unauthorized access to one or more of the monitored memory regions 132, such as an unauthorized write to a monitored memory region 132. Such unauthorized memory modifications may be performed by malicious software such as rootkits attempting to hook the system table, patch the OS or security software, or subvert control of the computing device 100. Security events may not include, for example, data conflicts not involving monitored memory regions 132, such as ordinary data conflicts between concurrently executing transactions and/or threads.

The computing device 100 may determine whether a security event has occurred based on the cause of the transactional abort. In block 316, in some embodiments the computing device 100 may read an abort status register to analyze the device state. For example, for Intel® architecture processors with Intel® TSX, the computing device 100 may read the EAX register. The abort status register may provide information on the reason for abort, such as the memory conflict type, whether an explicit abort instruction was encountered, or whether a breakpoint was encountered. For example, if the abort status register indicates that the transactional abort was not caused by a memory conflict, then a security event may not have occurred. In some embodiments, in block 318 the computing device 100 may read the performance monitoring unit (PMU) 126 to analyze the device (or processor) state. The PMU 126 may provide information to determine the cause of the transactional abort, including the memory addresses related to the abort, such as the address of the aborting instruction or the address of the conflicting data. For example, the computing device 100 may compare the memory address of the conflicting data with the memory addresses of the monitored memory regions 132 to determine whether the monitored memory regions 132 have been accessed. Thus, the computing device 100 may distinguish between a transactional abort caused by a security event and a transactional abort caused by a typical data conflict between concurrent transactions and/or threads.

In block 320, the computing device 100 determines whether a security event has occurred. As described above, a security event may occur when code from outside of the transaction 210 writes to the monitored memory regions 132. If a security event has not occurred, the method 300 loops back to block 302 to start another transaction and continue monitoring the monitored memory regions 132. If a security event has occurred, the method 300 advances to block 322.

In block 322, the computing device 100 reports the security event. The security event may be reported using any available technique, including displaying an interactive alert, generating a human readable report, attempting to reverse changes to the monitored memory regions 132, or performing another security operation. In some embodiments, in block 324 the computing device 100 may halt (e.g., cease executing code, power down, or restart). For example, the computing device 100 may halt to prevent potential execution of comprised code after the monitored memory regions 132 have been modified. After reporting the security event, the method 300 may be completed.

Referring now to FIG. 4, in use, the computing device 100 may execute a method 400 for dispatching security monitoring threads 208. The method 400 begins in block 402, in which the computing device 100 identifies one or more regions of the memory 130 to monitor. Those monitored memory regions 132 may be embodied as any important in-memory data structure or address range that should not be modified by executing code. For example, the monitored memory regions 132 may include the system call table or other system- or kernel-level data structures or code areas (e.g., to protect OS code from being patched or modified). As another example, the monitored memory regions 132 may include hypervisor or virtual machine monitor code or security software code. As still another example, the monitored memory regions 132 may include system integrity check routines, for example, segments of code responsible for verifying the integrity of the system call table, kernel, or other critical in-memory data structures.

In block 404, the computing device 100 assigns parts of the monitored memory regions 132 to one or more security threads 208. Each security thread 208 may be assigned a non-overlapping region of the monitored memory regions 132. For example, processors 120 supporting Intel® TSX may support transactional memory conflict detection at a cache line granularity (64 bytes). Thus, in such a computing device 100 supporting Intel® TSX, each security thread 208 may be assigned to monitored memory regions 132 located in different cache lines. Each security thread 208 may then monitor its own distinct monitored memory regions 132 independently of the other security threads 208. Of course, in some embodiments the computing device 100 may assign all of the monitored memory regions 132 to a single security thread 208. The number of security threads 208 and the size of the monitored memory regions 132 may depend on hardware limitations of the transactional memory support 124, and may be adjusted dynamically based on performance, as described further below.

In block 406, the computing device 100 starts the security threads 208. After being started, the security threads 208 each begin a transaction 210 and read the monitored memory locations 132, as described above in connection with the method 300 of FIG. 3. In some embodiments, in block 408 the computing device 100 may bind all of the security threads 208 to a single processor core 122. In other words, the security threads 208 may all be executed by a single processor core 122. Executing the security threads 208 by a single processor core 122 may improve performance by, for example, conserving transactional memory resources of the other processor cores 122, reducing the number of context switches required by the computing device 100, or improving responsiveness of the other processor cores 122. The computing device 100 may use any technique for binding the security threads 208 to a single processor core 122, for example by setting processor affinity using an operating system scheduler of the computing device 100. Additionally or alternatively, in some embodiments the computing device 100 may bind the security threads 208 to a set of the processor cores 122, for example, two of four available processor cores 122. Binding to a set of processor cores 122 may increase the transactional memory resources available to the security threads 208. For example, binding to more than one processor core 122 may increase maximum read set size, because the maximum read set size may depend on per-processor-core 122 hardware.

In block 410, the computing device 100 monitors performance attributes of the security threads 208 while the security threads 208 are executing. The computing device 100 may monitor any indication of how many transactional aborts are occurring and how long the computing device 100 spends handling the transactional aborts. In some embodiments, in block 412, the computing device 100 determines the number of security threads 208 that are currently executing. That number may be used, for example, for load balancing purposes or to determine whether resources are being utilized sub-optimally. In some embodiments, in block 414, the computing device 100 may determine a number of transactional aborts that have occurred. The computing device 100 may monitor the number of transactional aborts that occur for each security thread 208, the number of transactional aborts associated with particular monitored memory regions 132, the total number of transactional aborts in a given time period, or any other measurement of the volume of transactional aborts handled by the computing device 100. The computing device 100 may additionally monitor the individual security threads 208 to determine whether any of them are handling a transactional abort. In some embodiments, in block 416 the computing device 100 may determine an amount of time spent executing the abort handlers 134. The computing device 100 may measure total time spent by all security threads 208, average time per security thread 208, or any other measure of time spent handling transactional aborts.

In block 418, the computing device 100 may adjust the number of security threads 208 based on the measured performance attributes. In some embodiments, the computing device 100 may add or remove security threads 208 to perform load balancing, for example to achieve a particular number of transactional aborts per security thread 208, to adjust processor utilization or processing time of the security threads 208, to balance the size of the monitored memory regions 132 assigned to each of the security threads 208, to balance the number of transactional aborts generated by each of the monitored memory regions 132, or to otherwise control performance of the computing device 100. In some embodiments, the computing device 100 may add or remove security threads 208 to ensure that each security thread 208 may monitor its assigned monitored memory regions 132 without overflowing hardware capabilities of the transactional memory support 124 (e.g., without overflowing transactional buffers). In some embodiments, in block 420, the computing device 100 may add a backup security thread 208 to monitor a monitored memory region 132 when an existing security thread 208 is busy executing the abort handler 134 or otherwise processing a transactional abort. Adding a backup security thread 208 may allow the computing device 100 to ensure continuous or nearly continuous monitoring of all monitored memory regions 132, even when handling potential security events. After adjusting the number of security threads 208, the method 400 loops back to block 404 to reassign the monitored memory regions 132 and continue monitoring.

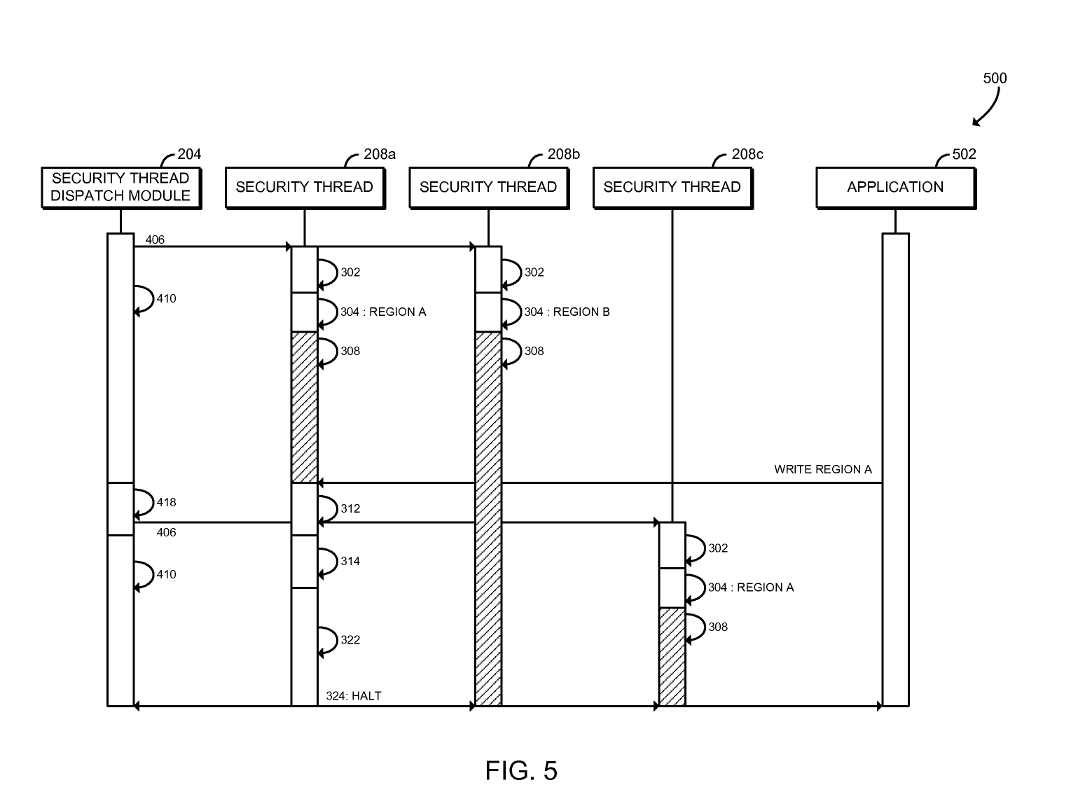

Referring now to FIG. 5, an activity diagram 500 illustrates at least one use of multiple security threads 208. The illustrative activity diagram 500 illustrates the security thread dispatch module 204, three security threads 208a through 208c, and an application 502. Of course, the computing device 100 may execute a lesser or greater number of security threads 208 and/or applications 502 in other embodiments. Each of those illustrated entities includes a lifeline extending downward to illustrate when each entity is active. The security thread dispatch module 204 begins by starting the security threads 208a, 208b as described above in connection with block 406 of FIG. 4. After starting the security threads 208a, 208b, the security thread dispatch module 204 monitors performance of the security threads 208 as described above in connection with the block 410 of FIG. 4.

After being started, the security thread 208a starts a new transaction 210 as described above in connection with the block 302 of FIG. 3. The security thread 208a then reads a monitored memory region 132 labeled as “region A,” as described above in connection with the block 304 of FIG. 3. After reading region A—and thus loading region A into the read set of the current transaction 210—the security thread 208a goes to sleep and monitors for transactional aborts as described above in connection with the block 308 of FIG. 3. Similarly, after being started, the security thread 208b starts a new transaction, reads a monitored memory region 132 labeled as “region B,” goes to sleep, and monitors for transactional aborts. The regions A and B do not overlap, meaning that threads 208a, 208b may each monitor for transactional aborts involving distinct memory regions. Note that the security thread 208c is initially inactive, unstarted, unscheduled, or otherwise not enabled.

The application 502 may be embodied as any application, operating system, hypervisor, or other code executing on the computing device 100. The application 502 may include transactional and/or non-transactional code. The application 502 executes concurrently or contemporaneously with the security thread dispatch module 204 and the security threads 208. The application 502 may execute normally, that is, without interference, code injection, or other modifications created by security software of the computing device 100. After executing for some time, the application 502 generates a memory write to region A, which is included in the monitored memory regions 132. The write to region A triggers a transactional abort to the security thread 208a. The security thread 208a executes the abort handler 134 in response to the transactional abort, as described above in connection with the block 312 of FIG. 3. While the security thread 208a executes the abort handler 134, note that the security thread 208b continues to sleep and monitor region B, a distinct monitored memory region 132. Thus, handling a transactional abort in one of the security threads 208 does not block or otherwise prevent detection of transactional aborts by the other security threads 208.

The security thread dispatch module 204 may determine that the security thread 208a has received a transactional abort. The security thread dispatch module 204 may use any technique to make this determination. For example, the security thread dispatch module 204 may periodically poll the status of the security threads 208, receive a callback message from the security threads 208 upon entering the abort handler 134, or perform any other appropriate technique. Upon determining or being notified that the security thread 208a is executing an abort handler 134 and therefore no longer monitoring the monitored memory regions 132, the security thread dispatch module 204 may determine that an additional thread should be added, as described above in connection with the block 418 of FIG. 4. Next, the security thread dispatch module 204 may start the security thread 208c as described above in connection with the block 406 of FIG. 4. After starting the security thread 208c, the security thread dispatch module 204 resumes monitoring performance of the security threads 208 as described above in connection with the block 410 of FIG. 4.

The security thread 208c starts a new transaction as described above in connection with the block 302 of FIG. 3. The security thread 208c then reads the monitored memory region 132 labeled as “region A,” as described above in connection with the security thread 208a. After reading region A, the security thread 208c goes to sleep and monitors for transactional aborts as described above in connection with the block 308 of FIG. 3. Thus, the security thread 208c may be a backup thread that monitors the region A while the security thread 208a is processing a transactional abort. By starting a backup security thread 208c, the computing device 100 may continue to detect memory conflicts in all of the monitored memory regions 132 while processing a previous transactional abort.

Referring back to security thread 208a, after executing the abort handler 134, the security thread 208a determines whether the transactional abort was caused by a security event, as described above in connection with the block 314 of FIG. 3. That determination occurs in response to the transactional abort, and may be performed by the abort handler 134 itself, or by another component of the computing device 100. In the illustrative example, the transactional abort was caused by a security event, so the security thread 208a reports the security event as described above in connection with the block 322 of FIG. 3. After reporting the security event, the security thread 208a halts the computing device 100 as described above in connection with the block 324 of FIG. 3. Halting the computing device 100 stops the execution of all the other entities shown in FIG. 5, including the security thread dispatch module 204, the security threads 208b, 208c, and the application 502.

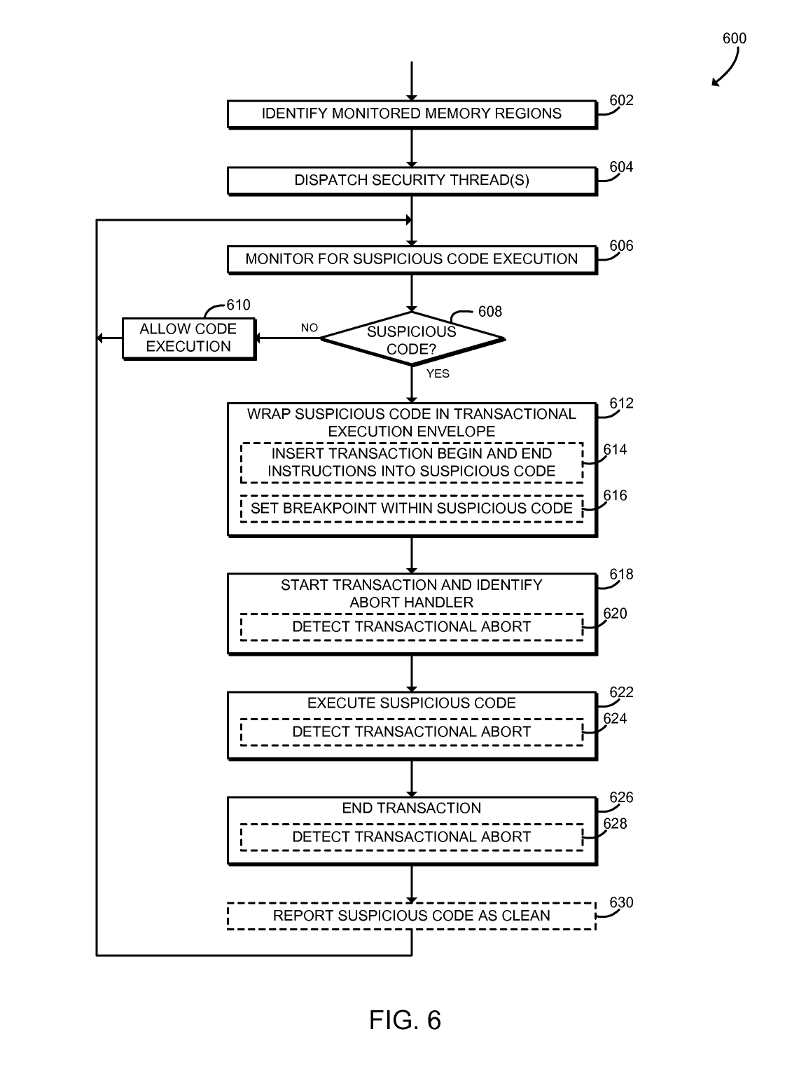

Referring now to FIG. 6, in use, the computing device 100 may execute a method 600 for executing suspicious code. The method 600 begins in block 602, in which the computing device 100 identifies one or more regions of the memory 130 to monitor during execution of the suspicious code. Determining the memory areas to monitor may be based on static and/or dynamic analysis of suspicious code. As described above in connection with FIG. 4, the monitored memory regions 132 may be embodied any important in-memory data structure or address range that should not be modified by executing code. For example, the monitored memory regions 132 may include the system call table or other system- or kernel-level data structures or code areas (e.g., to protect OS code from being patched or modified). As another example, the monitored memory regions 132 may include hypervisor or virtual machine monitor code or security software code.

In block 604, the computing device 100 dispatches one or more security threads 208 to monitor the monitored memory regions 132. The computing device 100 may execute the method 400 as described above in connection with FIG. 4 to dispatch the security threads 208.

In block 606, the computing device 100 monitors for execution of suspicious code. Suspicious code may include any code that is potentially or likely malicious. The computing device 100 may use any method to identify the suspicious code. For example, in some embodiments, the computing device 100 may monitor for and/or identify suspicious code based on metadata attributes such as whether the code is signed, whether the code was downloaded from the Internet, and so on. Additionally or alternatively, the computing device 100 may perform static analysis, dynamic analysis (e.g., based on emulation), or other heuristic analysis to identify potentially malicious code. As a simpler example, in some embodiments the computing device 100 may identify as suspicious any code that is to be executed.

In block 608, the computing device 100 determines whether any suspicious code has been identified. If not, the method 600 branches to block 610, in which the computing device 100 allows execution of code as normal and then loops back to block 606 to continue monitoring for suspicious code. If suspicious code has been identified, the method 600 advances to block 612.

In block 612, the computing device 100 wraps the suspicious code in a transactional execution envelope. Wrapping the suspicious code allows the suspicious code to be executed in a transaction. Any method for wrapping the suspicious code compatible with the transactional memory support 124 of the processor 120 may be used. In some embodiments, in block 614 the computing device 100 may insert transaction-begin and transaction-end instructions into or around the suspicious code, for example by using a hypervisor to execute corresponding instructions in the context of the suspicious code or by using an instrumentation. In some embodiments, the inserted instructions may be made invisible to the suspicious code. Additionally or alternatively, in some embodiments the computing device 100 may insert only a transaction-begin instruction to wrap the suspicious code. In those embodiments, execution may continue until a transactional abort occurs, either in response to a security event, when transactional buffers are exceeded, or for any other reason. The transaction-begin and transaction-end instructions may be embodied as machine instructions interpreted by the processor 120 to signal the beginning and end of a transaction, respectively. For example, on Intel® architecture processors with Intel® Transactional Synchronization Extensions (Intel® TSX), the transaction begin and transaction end instructions may be embodied as instructions having the mnemonics XBEGIN and XEND, respectively.

In some embodiments, in block 616 the computing device 100 may set a breakpoint or an explicit abort instruction within the suspicious code. The breakpoint may be set for a monitored memory region 132 within the suspicious code that the computing device 100 has determined should not be executed. The breakpoint may be embodied as any instruction, data, or other setting that causes the processor 120 to generate a transactional abort when attempting to execute that particular location in memory. For example, the breakpoint may be set by inserting an explicit transaction abort instruction, such as an instruction having the mnemonic XABORT on Intel® architecture processors with Intel® TSX. Additionally or alternatively, the breakpoint may be set by inserting any other suitable instruction or set of instructions that causes a transactional abort (e.g., a breakpoint interrupt instruction, an illegal instruction, or a sequence of instructions causing overflow of internal CPU transaction-tracking storage resulting in an abort). Additionally or alternatively, the breakpoint may be set by storing a particular value in a debug register of the processor 120. Setting the breakpoint may allow the computing device 100 to monitor for execution of a potentially malicious location within the suspicious code.

In block 618, the computing device 100 starts the transaction and identifies an associated abort handler. The computing device 100 may identify an abort handler 134 used in connection with the security threads 208 or a different abort handler. The abort handler may determine whether the transactional abort was caused by a security event, report any security events that occur, or perform any other appropriate security operation. In some embodiments, the transaction may be started by executing a particular instruction, for example the XBEGIN instruction. The address of the abort handler may be passed as an argument to the transaction-begin instruction. Additionally or alternatively, a separate instruction may exist for specifying address of the abort handler. As described above, if a transactional abort occurs during execution of the transaction, the processor 120 calls the abort handler. While starting the transaction in block 618, in block 620 the computing device 100 may detect a transactional abort, for example a transactional abort caused by a memory conflict between the transaction and one or more of the security threads 208. Of course, transactional aborts may have other causes such as exceeding hardware limits on transaction size or encountering an instruction not supported for transactional execution (e.g., an attempted I/O instruction).

In block 622, the computing device 100 executes the suspicious code within the transaction. Thus, the suspicious code may be executed concurrently or contemporaneously with the security threads 208. While executing the suspicious code in block 622, in block 624 the computing device 100 may detect a transactional abort. A transactional abort may be generated, for example, if the suspicious code writes to a monitored memory region 132 that has been read by a security thread 208. The transactional abort may be generated immediately upon the conflicting write or at a later time. Additionally or alternatively, a transactional abort may be generated upon encountering a breakpoint previously set within the suspicious code or an explicit abort instruction inserted within the suspicious code. In response to a transactional abort, the transaction is rolled back, reversing any changes made to the memory 130 by the suspicious code. As described above, a transactional abort may also be generated when the capacity of transactional buffers are exceeded, for example when the computing device 100 has inserted a transaction-begin instruction without a corresponding transaction-end instruction. In those embodiments, the computing device 100 may inject another transact-begin instruction, for example to continue monitoring the suspicious code after the last instruction executed before the transactional abort.

In block 626, the computing device 100 ends the transaction after completion of the suspicious code. In some embodiments, the transaction may be ended by executing a particular instruction, for example the XEND instruction. Ending the transaction may cause the computing device 100 to validate the transaction prior to committing the transaction. Validating the transaction may include validating the read set and/or write set of the transaction to determine whether any memory conflicts have occurred during execution of the transaction. While ending the transaction in block 626, in block 628 the computing device 100 may detect a transactional abort. For example, a transactional abort may be raised upon failure to validate and/or commit the transaction for any reason. Additionally or alternatively, in some embodiments, the computing device 100 may implement an “eager” validation mechanism where the validation (including conflict detection) happens as soon as possible after issuing memory requests or after encountering any abort condition. Further, in some embodiments an explicit transaction-end instruction may be absent, in which case the transaction may end implicitly due to exhausting the capacity of storage used to track transactional conflicts.

After successfully ending the transaction including the suspicious code, the method 600 may advance to block 630, or in some embodiments, loop back to block 606. Successful completion of the transaction indicates that no security events have occurred during execution of the suspicious code; that is, the suspicious code did not attempt unauthorized access to any of the monitored memory regions 132, including attempted execution of suspicious code marked with breakpoints. In some embodiments, in block 630 the computing device 100 may report the suspicious code as clean. The computing device 100 may use any reporting method; for example, the computing device 100 may generate an interactive alert, send a message or invoke a call or callback to at least one software module, generate a human readable report, add the suspicious code to a whitelist to allow future execution, or perform other security-related tasks. After completion of block 630, the method 600 loops back to block 606 to continue monitoring for suspicious code execution.

### EXAMPLES

Illustrative examples of the technologies disclosed herein are provided below. An embodiment of the technologies may include any one or more, and any combination of, the examples described below.

Example 1 includes a computing device for detecting unauthorized memory accesses, the computing device comprising a security thread dispatch module to start a security thread; and a security thread module to start a transactional memory envelope within the security thread; access a monitored memory location within the transactional memory envelope; detect a transactional abort in response to the access of the monitored memory location; determine whether a security event has occurred in response to detection of the transactional abort, the security event indicative of an unauthorized write to the monitored memory location that originates from outside of the transactional memory envelope; and report the security event in response to a determination that the security event has occurred.

Example 2 includes the subject matter of Examples 1, and wherein the monitored memory location comprises a system call table of the computing device, security software of the computing device, part of a hypervisor of the computing device, or a part of a kernel of the computing device.

Example 3 includes the subject matter of any of Examples 1 and 2, and wherein the monitored memory location comprises a system integrity check routine of the computing device.

Example 4 includes the subject matter of any of Examples 1-3, and wherein to access the monitored memory location comprises to read the monitored memory location.

Example 5 includes the subject matter of any of Examples 1-4, and wherein the security thread module is further to yield execution of the security thread in response to the access of the monitored memory location.

Example 6 includes the subject matter of any of Examples 1-5, and wherein to determine whether the security event has occurred comprises to compare a first memory address of a conflicting data location retrieved from a performance monitoring unit of the computing device to a second memory address of the monitored memory location.

Example 7 includes the subject matter of any of Examples 1-6, and wherein to determine whether the security event has occurred comprises to determine a cause of the transactional abort based on an abort status register of the computing device.

Example 8 includes the subject matter of any of Examples 1-7, and wherein to report the security event comprises to halt the computing device.

Example 9 includes the subject matter of any of Examples 1-8, and wherein the security thread module is further to execute a transactional abort handler in response to the detection of the transactional abort; wherein to start the transactional memory envelope comprises to identify the transactional abort handler; and to execute the transactional abort handler comprises to determine whether the security event has occurred.

Example 10 includes the subject matter of any of Examples 1-9, and wherein the security thread module is further to restart the transactional memory envelope in response to a determination that the security event has not occurred.

Example 11 includes the subject matter of any of Examples 1-10, and wherein the security thread dispatch module is further to start a second security thread; and the security thread module is further to start a second transactional memory envelope within the second security thread; access a second monitored memory location within the second transactional memory envelope, wherein the second monitored memory location and the monitored memory location do not overlap; and monitor for a second transactional abort by the second transactional memory envelope contemporaneously with the determination whether the security event has occurred.

Example 12 includes the subject matter of any of Examples 1-11, and wherein the security thread dispatch module is further to bind the security thread and the second security thread for execution by a dedicated processor core of the computing device.

Example 13 includes the subject matter of any of Examples 1-12, and wherein the security thread dispatch module is further to start a set of security threads, wherein the set includes the security thread; monitor a performance attribute of the set of security threads; and adjust the number of security threads included in the set of security threads based on the monitored performance attribute; and the security thread module is further to start a transactional memory envelope within each security thread of the set of security threads; and access a distinct monitored memory location within each transactional memory envelope of the set of security threads.

Example 14 includes the subject matter of any of Examples 1-13, and wherein the performance attribute comprises a number of transactional aborts detected, a time spent handling transactional aborts, or a size of the distinct monitored memory location of each transactional memory envelope.

Example 15 includes the subject matter of any of Examples 1-14, and wherein the security thread dispatch module is further to start a second security thread in response to the detection of the transactional abort; and the security thread module is further to (i) start a second transactional memory envelope within the second security thread, (ii) access the monitored memory location within the second transactional memory envelope, and (iii) monitor for a second transactional abort by the second transactional memory envelope contemporaneously with the determination of whether the security event has occurred.

Example 16 includes the subject matter of any of Examples 1-15, and wherein the security thread dispatch module is further to (i) start a second security thread and (ii) start a third security thread in response to the detection of the transactional abort; and the security thread module is further to start a second transactional memory envelope within the second security thread; access a second monitored memory location within the second transactional memory envelope, wherein the second monitored memory location and the monitored memory location do not overlap; start a third transactional memory envelope within the third security thread; access the monitored memory location within the third transactional memory envelope; and monitor for a second transactional abort by the second transactional memory envelope and the third transactional envelope contemporaneously with the determination of whether the security event has occurred.

Example 17 includes the subject matter of any of Examples 1-16, and further comprising a security module to determine whether a code segment is suspicious; execute the code segment in response to the access of the monitored memory location and a determination that the code segment is not suspicious; and in response to a determination that the code segment is suspicious wrap the code segment in a second transactional memory envelope; and execute the code segment within the second transactional memory envelope in response to the access of the monitored memory location.

Example 18 includes the subject matter of any of Examples 1-17, and wherein to wrap the code segment comprises to insert a transaction begin instruction in the code segment.

Example 19 includes the subject matter of any of Examples 1-18, and wherein to wrap the code segment further comprises to insert a transaction end instruction in the code segment.

Example 20 includes a method for detecting unauthorized memory accesses, the method comprising starting, by a computing device, a security thread; starting, by the computing device, a transactional memory envelope within the security thread; accessing, by the computing device, a monitored memory location within the transactional memory envelope; detecting, by the computing device, a transactional abort in response to accessing the monitored memory location; determining, by the computing device, whether a security event has occurred in response to detecting the transactional abort, the security event indicative of an unauthorized write to the monitored memory location originating from outside of the transactional memory envelope; and reporting, by the computing device, the security event in response to determining the security event has occurred.

Example 21 includes the subject matter of Example 20, and wherein the monitored memory location comprises a system call table of the computing device, security software of the computing device, part of a hypervisor of the computing device, or a part of a kernel of the computing device.

Example 22 includes the subject matter of any of Examples 20 and 21, and wherein the monitored memory location comprises a system integrity check routine of the computing device.

Example 23 includes the subject matter of any of Examples 20-22, and wherein accessing the monitored memory location comprises reading the monitored memory location.

Example 24 includes the subject matter of any of Examples 20-23, and further comprising yielding, by the computing device, execution of the security thread in response to accessing the monitored memory location.

Example 25 includes the subject matter of any of Examples 20-24, and wherein determining whether the security event has occurred comprises comparing a first memory address of a conflicting data location retrieved from a performance monitoring unit of the computing device to a second memory address of the monitored memory location.

Example 26 includes the subject matter of any of Examples 20-25, and wherein determining whether the security event has occurred comprises determining a cause of the transactional abort based on an abort status register of the computing device.

Example 27 includes the subject matter of any of Examples 20-26, and wherein reporting the security event comprises halting the computing device.

Example 28 includes the subject matter of any of Examples 20-27, and further comprising executing, by the computing device, a transactional abort handler in response to detecting the transactional abort; wherein starting the transactional memory envelope comprises identifying the transactional abort handler; and executing the transactional abort handler comprises determining whether the security event has occurred.

Example 29 includes the subject matter of any of Examples 20-28, and further comprising restarting, by the computing device, the transactional memory envelope in response to determining the security event has not occurred.

Example 30 includes the subject matter of any of Examples 20-29, and further comprising starting, by the computing device, a second security thread; starting, by the computing device, a second transactional memory envelope within the second security thread; accessing, by the computing device, a second monitored memory location within the second transactional memory envelope, wherein the second monitored memory location and the monitored memory location do not overlap; and monitoring, by the computing device, for a second transactional abort by the second transactional memory envelope while determining whether the security event has occurred.

Example 31 includes the subject matter of any of Examples 20-30, and further comprising binding, by the computing device, the security thread and the second security thread for execution by a dedicated processor core of the computing device.

Example 32 includes the subject matter of any of Examples 20-31, and further comprising starting, by the computing device, a set of security threads, wherein the set includes the security thread, starting, by the computing device, a transactional memory envelope within each security thread of the set of security threads; accessing, by the computing device, a distinct monitored memory location within each transactional memory envelope of the set of security threads; monitoring, by the computing device, a performance attribute of the set of security threads; and adjusting, by the computing device, the number of security threads included in the set of security threads based on the monitored performance attribute.

Example 33 includes the subject matter of any of Examples 20-32, and wherein monitoring the performance attribute comprises monitoring a number of transactional aborts detected, a time spent handling transactional aborts, or a size of the distinct monitored memory location of each transactional memory envelope.

Example 34 includes the subject matter of any of Examples 20-33, and further comprising starting, by a computing device, a second security thread in response to detecting the transactional abort; starting, by the computing device, a second transactional memory envelope within second security thread; accessing, by the computing device, the monitored memory location within the second transactional memory envelope; and monitoring, by the computing device, for a second transactional abort by the second transactional memory envelope while determining whether the security event has occurred.

Example 35 includes the subject matter of any of Examples 20-34, and further comprising starting, by a computing device, a second security thread; starting, by the computing device, a second transactional memory envelope within the second security thread; accessing, by the computing device, a second monitored memory location within the second transactional memory envelope, wherein the second monitored memory location and the monitored memory location do not overlap; starting, by a computing device, a third transactional memory envelope in response to detecting the transactional abort; starting, by the computing device, a third transactional memory envelope within the third security thread; accessing, by the computing device, the monitored memory location within the third transactional memory envelope; and monitoring, by the computing device, for a second transactional abort by the second transactional memory envelope and the third transactional envelope while determining whether the security event has occurred.

Example 36 includes the subject matter of any of Examples 20-35, and further comprising determining, by the computing device, whether a code segment is suspicious; executing, by the computing device, the code segment in response to accessing the monitored memory location and determining the code segment is not suspicious; and in response to determining the code segment is suspicious wrapping, by the computing device, the code segment in a second transactional memory envelope; and executing, by the computing device, the code segment within the second transactional memory envelope in response to accessing the monitored memory location.

Example 37 includes the subject matter of any of Examples 20-36, and wherein wrapping the code segment comprises inserting a transaction begin instruction in the code segment.

Example 38 includes the subject matter of any of Examples 20-37, and wherein wrapping the code segment further comprises inserting a transaction end instruction in the code segment.

Example 39 includes a computing device comprising a processor; and a memory having stored therein a plurality of instructions that when executed by the processor cause the computing device to perform the method of any of Examples 20-38.

Example 40 includes one or more machine readable storage media comprising a plurality of instructions stored thereon that in response to being executed result in a computing device performing the method of any of Examples 20-38.

Example 41 includes a computing device comprising means for performing the method of any of Examples 20-38.

Example 42 includes a computing device for detecting unauthorized memory accesses, the computing device comprising means for starting a security thread; means for starting a transactional memory envelope within the security thread; means for accessing a monitored memory location within the transactional memory envelope; means for detecting a transactional abort in response to accessing the monitored memory location; means for determining whether a security event has occurred in response to detecting the transactional abort, the security event indicative of an unauthorized write to the monitored memory location originating from outside of the transactional memory envelope; and means for reporting the security event in response to determining the security event has occurred.

Example 43 includes the subject matter of Example 42, and wherein the monitored memory location comprises a system call table of the computing device, security software of the computing device, part of a hypervisor of the computing device, or a part of a kernel of the computing device.

Example 44 includes the subject matter of any of Examples 42 and 43, and wherein the monitored memory location comprises a system integrity check routine of the computing device.

Example 45 includes the subject matter of any of Examples 42-44, and wherein the means for accessing the monitored memory location comprises means for reading the monitored memory location.

Example 46 includes the subject matter of any of Examples 42-45, and further comprising means for yielding execution of the security thread in response to accessing the monitored memory location.

Example 47 includes the subject matter of any of Examples 42-46, and wherein the means for determining whether the security event has occurred comprises means for comparing a first memory address of a conflicting data location retrieved from a performance monitoring unit of the computing device to a second memory address of the monitored memory location.

Example 48 includes the subject matter of any of Examples 42-47, and wherein the means for determining whether the security event has occurred comprises means for determining a cause of the transactional abort based on an abort status register of the computing device.

Example 49 includes the subject matter of any of Examples 42-48, and wherein the means for reporting the security event comprises means for halting the computing device.

Example 50 includes the subject matter of any of Examples 42-49, and further comprising means for executing a transactional abort handler in response to detecting the transactional abort; wherein the means for starting the transactional memory envelope comprises means for identifying the transactional abort handler; and the means for executing the transactional abort handler comprises means for determining whether the security event has occurred.

Example 51 includes the subject matter of any of Examples 42-50, and further comprising means for restarting the transactional memory envelope in response to determining the security event has not occurred.

Example 52 includes the subject matter of any of Examples 42-51, and further comprising means for starting a second security thread; means for starting a second transactional memory envelope within the second security thread; means for accessing a second monitored memory location within the second transactional memory envelope, wherein the second monitored memory location and the monitored memory location do not overlap; and means for monitoring for a second transactional abort by the second transactional memory envelope while determining whether the security event has occurred.

Example 53 includes the subject matter of any of Examples 42-52, and further comprising means for binding the security thread and the second security thread for execution by a dedicated processor core of the computing device.

Example 54 includes the subject matter of any of Examples 42-53, and further comprising means for starting a set of security threads, wherein the set includes the security thread, means for starting a transactional memory envelope within each security thread of the set of security threads; means for accessing a distinct monitored memory location within each transactional memory envelope of the set of security threads; means for monitoring a performance attribute of the set of security threads; and means for adjusting the number of security threads included in the set of security threads based on the monitored performance attribute.

Example 55 includes the subject matter of any of Examples 42-54, and wherein the means for monitoring the performance attribute comprises means for monitoring a number of transactional aborts detected, a time spent handling transactional aborts, or a size of the distinct monitored memory location of each transactional memory envelope.

Example 56 includes the subject matter of any of Examples 42-55, and further comprising means for starting a second security thread in response to detecting the transactional abort; means for starting a second transactional memory envelope within second security thread; means for accessing the monitored memory location within the second transactional memory envelope; and means for monitoring for a second transactional abort by the second transactional memory envelope while determining whether the security event has occurred.

Example 57 includes the subject matter of any of Examples 42-56, and further comprising means for starting a second security thread; means for starting a second transactional memory envelope within the second security thread; means for accessing a second monitored memory location within the second transactional memory envelope, wherein the second monitored memory location and the monitored memory location do not overlap; means for starting a third transactional memory envelope in response to detecting the transactional abort; means for starting a third transactional memory envelope within the third security thread; means for accessing the monitored memory location within the third transactional memory envelope; and means for monitoring for a second transactional abort by the second transactional memory envelope and the third transactional envelope while determining whether the security event has occurred.

Example 58 includes the subject matter of any of Examples 42-57, and further comprising means for determining whether a code segment is suspicious; means for executing the code segment in response to accessing the monitored memory location and determining the code segment is not suspicious; and in response to determining the code segment is suspicious means for wrapping the code segment in a second transactional memory envelope; and means for executing the code segment within the second transactional memory envelope in response to accessing the monitored memory location.

Example 59 includes the subject matter of any of Examples 42-58, and wherein the means for wrapping the code segment comprises means for inserting a transaction begin instruction in the code segment.

Example 60 includes the subject matter of any of Examples 42-59, and wherein the means for wrapping the code segment further comprises means for inserting a transaction end instruction in the code segment.

1. A computing device for detecting unauthorized memory accesses, the computing device comprising:
a security thread dispatch module to start a security thread; and
a security thread module to:
start a transactional memory envelope within the security thread;
access a monitored memory location within the transactional memory envelope;
detect a transactional abort in response to the access of the monitored memory location;
determine whether a security event has occurred in response to detection of the transactional abort, the security event indicative of an unauthorized write to the monitored memory location that originates from outside of the transactional memory envelope; and
report the security event in response to a determination that the security event has occurred.

2. The computing device of claim 1, wherein the monitored memory location comprises a system call table of the computing device, security software of the computing device, part of a hypervisor of the computing device, or a part of a kernel of the computing device.

3. The computing device of claim 1, wherein the monitored memory location comprises a system integrity check routine of the computing device.

4. The computing device of claim 1, wherein the security thread module is further to yield execution of the security thread in response to the access of the monitored memory location.

5. The computing device of claim 1, wherein:
the security thread dispatch module is further to start a second security thread; and
the security thread module is further to:
start a second transactional memory envelope within the second security thread;
access a second monitored memory location within the second transactional memory envelope, wherein the second monitored memory location and the monitored memory location do not overlap; and
monitor for a second transactional abort by the second transactional memory envelope contemporaneously with the determination whether the security event has occurred.

6. The computing device of claim 5, wherein the security thread dispatch module is further to bind the security thread and the second security thread for execution by a dedicated processor core of the computing device.

7. The computing device of claim 1, wherein:
the security thread dispatch module is further to:
start a set of security threads, wherein the set includes the security thread;
monitor a performance attribute of the set of security threads; and
adjust the number of security threads included in the set of security threads based on the monitored performance attribute; and
the security thread module is further to:
start a transactional memory envelope within each security thread of the set of security threads; and
access a distinct monitored memory location within each transactional memory envelope of the set of security threads.

8. The computing device of claim 7, wherein the performance attribute comprises a number of transactional aborts detected, a time spent handling transactional aborts, or a size of the distinct monitored memory location of each transactional memory envelope.

9. The computing device of claim 1, wherein:
the security thread dispatch module is further to start a second security thread in response to the detection of the transactional abort; and
the security thread module is further to (i) start a second transactional memory envelope within the second security thread, (ii) access the monitored memory location within the second transactional memory envelope, and (iii) monitor for a second transactional abort by the second transactional memory envelope contemporaneously with the determination of whether the security event has occurred.

10. The computing device of claim 1, further comprising a security module to:
determine whether a code segment is suspicious;
execute the code segment in response to the access of the monitored memory location and a determination that the code segment is not suspicious; and
in response to a determination that the code segment is suspicious:
wrap the code segment in a second transactional memory envelope; and
execute the code segment within the second transactional memory envelope in response to the access of the monitored memory location.

11. A method for detecting unauthorized memory accesses, the method comprising:
starting, by a computing device, a security thread;
starting, by the computing device, a transactional memory envelope within the security thread;
accessing, by the computing device, a monitored memory location within the transactional memory envelope;
detecting, by the computing device, a transactional abort in response to accessing the monitored memory location;
determining, by the computing device, whether a security event has occurred in response to detecting the transactional abort, the security event indicative of an unauthorized write to the monitored memory location originating from outside of the transactional memory envelope; and
reporting, by the computing device, the security event in response to determining the security event has occurred.

12. The method of claim 11, further comprising yielding, by the computing device, execution of the security thread in response to accessing the monitored memory location.

13. The method of claim 11, further comprising:
starting, by the computing device, a second security thread;
starting, by the computing device, a second transactional memory envelope within the second security thread;
accessing, by the computing device, a second monitored memory location within the second transactional memory envelope, wherein the second monitored memory location and the monitored memory location do not overlap; and
monitoring, by the computing device, for a second transactional abort by the second transactional memory envelope while determining whether the security event has occurred.

14. The method of claim 11, further comprising:
starting, by the computing device, a set of security threads, wherein the set includes the security thread,
starting, by the computing device, a transactional memory envelope within each security thread of the set of security threads;
accessing, by the computing device, a distinct monitored memory location within each transactional memory envelope of the set of security threads;
monitoring, by the computing device, a performance attribute of the set of security threads; and
adjusting, by the computing device, the number of security threads included in the set of security threads based on the monitored performance attribute.

15. The method of claim 11, further comprising:
starting, by a computing device, a second security thread in response to detecting the transactional abort;
starting, by the computing device, a second transactional memory envelope within second security thread;
accessing, by the computing device, the monitored memory location within the second transactional memory envelope; and
monitoring, by the computing device, for a second transactional abort by the second transactional memory envelope while determining whether the security event has occurred.

16. The method of claim 11, further comprising:
determining, by the computing device, whether a code segment is suspicious;
executing, by the computing device, the code segment in response to accessing the monitored memory location and determining the code segment is not suspicious; and
in response to determining the code segment is suspicious:
wrapping, by the computing device, the code segment in a second transactional memory envelope; and
executing, by the computing device, the code segment within the second transactional memory envelope in response to accessing the monitored memory location.

17. One or more computer-readable storage media comprising a plurality of instructions that in response to being executed cause a computing device to:
start a security thread;
start a transactional memory envelope within the security thread;
access a monitored memory location within the transactional memory envelope;
detect a transactional abort in response to accessing the monitored memory location;
determine whether a security event has occurred in response to detecting the transactional abort, the security event indicative of an unauthorized write to the monitored memory location originating from outside of the transactional memory envelope; and
report the security event in response to determining the security event has occurred.

18. The one or more computer-readable storage media of claim 17, further comprising a plurality of instructions that in response to being executed cause the computing device to yield execution of the security thread in response to accessing the monitored memory location.

19. The one or more computer-readable storage media of claim 17, further comprising a plurality of instructions that in response to being executed cause the computing device to:
start a second security thread;
start a second transactional memory envelope within the second security thread;
access a second monitored memory location within the second transactional memory envelope, wherein the second monitored memory location and the monitored memory location do not overlap; and
monitor for a second transactional abort by the second transactional memory envelope while determining whether the security event has occurred.

20. The one or more computer-readable storage media of claim 17, further comprising a plurality of instructions that in response to being executed cause the computing device to:
start a set of security threads, wherein the set includes the security thread,
start a transactional memory envelope within each security thread of the set of security threads;
access a distinct monitored memory location within each transactional memory envelope of the set of security threads;
monitor a performance attribute of the set of security threads; and
adjust the number of security threads included in the set of security threads based on the monitored performance attribute.

21. The one or more computer-readable storage media of claim 17, further comprising a plurality of instructions that in response to being executed cause the computing device to:
start a second security thread in response to detecting the transactional abort;
start a second transactional memory envelope within second security thread;
access the monitored memory location within the second transactional memory envelope; and
monitor for a second transactional abort by the second transactional memory envelope while determining whether the security event has occurred.

22. The one or more computer-readable storage media of claim 17, further comprising a plurality of instructions that in response to being executed cause the computing device to:
determine whether a code segment is suspicious;
execute the code segment in response to accessing the monitored memory location and determining the code segment is not suspicious; and
in response to determining the code segment is suspicious:
wrap the code segment in a second transactional memory envelope; and
execute the code segment within the second transactional memory envelope in response to accessing the monitored memory location.
